(19) United States
(12) Patent Application Publication
(10) Pub. No.: US 2026/0126403 A1
(43) Pub. Date: May 7, 2026

(54) X-RAY EQUIPMENT FOR SEMICONDUCTOR STRUCTURAL INSPECTION AND METHOD FOR INSPECTING SEMICONDUCTOR STRUCTURE

(71) Applicant: Samsung Electronics Co., Ltd., Suwon-si (KR)

(72) Inventors: Garam Choi, Suwon-si (KR); Taejin Kwon, Suwon-si (KR); Jungho Moon, Suwon-si (KR); Myoungki Ahn, Suwon-si (KR); Seungryeol Lee, Suwon-si (KR); Hyeongcheol Lee, Suwon-si (KR); Sukbum Hong, Suwon-si (KR)

(21) Appl. No.: 19/359,864

(22) Filed: Oct. 16, 2025

(30) Foreign Application Priority Data
Nov. 4, 2024 (KR) 10-2024-0154596
Jul. 28, 2025 (KR) 10-2025-0102214

(51) Int. Cl. G01N 23/044

(52) U.S. Cl. CPC G01N 23/044; G01N 2223/1016; G01N 2223/306; G01N 2223/313; G01N 2223/33; G01N 2223/505; G01N 2223/6116; G01N 2223/646

(57) ABSTRACT

X-ray equipment for semiconductor structure inspection includes an X-ray source configured to radiate an X-ray beam to a target region of an object to be inspected, a scintillator configured to output visible light in a visible light wavelength band in response to a particular wavelength band among wavelength bands of the X-ray beam, a detector configured to generate a detection signal in response to the visible light, and a controller configured to determine defects in the object to be inspected using the detection signal. The scintillator is disposed between the object to be inspected and the detector.

### CROSS-REFERENCE TO RELATED APPLICATION

This application claims the priority and benefit of Korean Patent Application Nos. 10-2024-0154596, filed on Nov. 4, 2024, and 10-2025-0102214, filed on Jul. 28, 2025 with the Korean Intellectual Property Office, the entire contents of each of which are incorporated herein by reference.

### BACKGROUND

The present disclosure relates to X-ray equipment for semiconductor structure inspection and a method for inspecting a semiconductor structure, and more particularly, to X-ray equipment for semiconductor structure inspection and a method for inspecting a semiconductor structure for detecting defects in structures included in an object to be inspected with high resolution.

A stacking method is being widely introduced not only in semiconductor package products but also in pre-process products (e.g., a BVNAND, W2W bonding, or the like) which complete chips by engraving circuits on semiconductor wafers. Accordingly, the need to inspect or measure microscopic defects therebelow in a three-dimensional structure of semiconductor products is greatly increasing. Since existing optical/electron microscope methods have limitations, attempts to utilize new types of equipment such as ultrasound and X-ray are gradually increasing.

X-ray equipment allows X-rays to pass through a sample to view an interior of the sample, and includes Computed Laminography (CL) technology, Computed Tomography (CT) technology, and the like. CT technology has a limitation in the application of the technology to semiconductor wafer inspection/measurement, for example, because it cannot transmit light when a semiconductor wafer with a diameter of 300 mm is parallel to incident light. For this reason, CT technology, in which the incident light is incident obliquely toward a sample surface, has emerged in inline X-ray equipment for semiconductor structure inspection.

The CL technology may uniformly measure wide and thin samples for semiconductor structure inspection, such as a semiconductor wafer with a diameter of 300 mm or an advanced semiconductor package (AVP), but has lower resolution than that of CT technology.

Low resolution makes it difficult if not impossible to measure defects such as voids within a microbump μBump of 1 μm or less in the advanced package and not-wet defects, which are microscopic contact defects.

In the semiconductor industry, inline X-ray CT/CL equipment is being applied to semiconductor inspection. The application of such X-ray equipment to the semiconductor industry is relatively recent, and when the current X-ray equipment of a monochrome black and white spectrometer is applied to the semiconductor industry as is, there may be a problem in that it may be difficult to measure the same through semiconductor structures of micrometer (μm) size due to insufficient resolution and contrast.

### SUMMARY

An aspect of the present inventive concept provides X-ray equipment for semiconductor structure inspection and a method for inspecting a semiconductor structure for accurately determining defects in a target region irradiated with an X-ray beam in an object to be inspected, by obtaining a detection signal by separating a wavelength band of an X-ray beam emitted by an X-ray source.

In addition, an aspect of the present inventive concept provides #X-ray equipment for semiconductor structure inspection and a method for inspecting a semiconductor structure for obtaining a high-resolution image by selecting wavelength bands having different absorption rates for materials of structures included in a target region.

According to an aspect of the present inventive concept, X-ray equipment for semiconductor structure inspection includes an X-ray source configured to radiate an X-ray beam to a target region of an object to be inspected, a scintillator configured to output visible light in a visible light wavelength band in response to a particular wavelength band among wavelength bands of the X-ray beam, a detector configured to generate a detection signal in response to the visible light, and a controller configured to determine defects in the object to be inspected using the detection signal. The scintillator is disposed between the object to be inspected and the detector.

According to an aspect of the present inventive concept, inline X-ray equipment for semiconductor structure inspection includes an X-ray source configured to radiate a broadband X-ray beam within an X-ray wavelength band obliquely to a target region of an object to be inspected, a first scintillator configured to output first visible light in response to a first particular wavelength band of the X-ray beam having passed through the target region, a second scintillator configured to output second visible light in response to a second wavelength band of the X-ray beam having passed through the target region, and a detector configured to output a detection signal in response to the first visible light and the second visible light.

According to an aspect of the present inventive concept, a method for inspecting a semiconductor structure includes radiating a target region of an object to be inspected with an X-ray beam having a cone beam shape; exposing a detector to visible light using a scintillator reacting to the X-ray beam having passed through the target region; obtaining a detection signal output by the detector; and generating an image representing measurement patterns included in the target region using the detection signal. The image is generated using a first detection signal output by the detector and corresponding to a first particular wavelength band of the X-ray beam, and a second detection signal output by the detector and corresponding to a second particular wavelength band of the X-ray beam.

### BRIEF DESCRIPTION OF DRAWINGS

The above and other aspects, features, and advantages of the present inventive concept will be more clearly understood from the following detailed description taken in conjunction with the accompanying drawings, in which:

FIG. 1 is a schematic diagram of X-ray equipment for semiconductor structure inspection according to an example embodiment of the present inventive concept.

FIG. 2 is a schematic diagram of X-ray equipment for semiconductor structure inspection according to an example embodiment of the present inventive concept.

FIG. 3 is a schematic diagram illustrating a spectral filter used in X-ray equipment for semiconductor structure inspection according to an example embodiment of the present inventive concept.

FIG. 4 is a flow chart for an analysis method of X-ray equipment for semiconductor structure inspection according to an example embodiment of the present inventive concept.

FIGS. 5A and 5B are graphs of a method for inspecting a semiconductor structure according to an example embodiment of the present inventive concept.

FIGS. 6A to 6C are diagrams illustrating inspection results of X-ray equipment for semiconductor structure inspection according to an example embodiment of the present inventive concept.

FIG. 7 is a diagram illustrating inspection results of X-ray equipment for semiconductor structure inspection according to an example embodiment of the present inventive concept.

FIG. 8 is a diagram illustrating inspection results of X-ray equipment for semiconductor structure inspection according to an example embodiment of the present inventive concept.

FIGS. 9A to 9C are diagrams illustrating inspection results of X-ray equipment for semiconductor structure inspection according to an example embodiment of the present inventive concept.

FIGS. 10A to 10C are diagrams illustrating inspection results of X-ray equipment for semiconductor structure inspection according to an example embodiment of the present inventive concept.

Some of the drawings are included as schematics. The drawings are for illustrative purposes only and should not be considered to be drawn to scale. Further, drawings as schematic diagrams are provided to aid understanding and may not include all aspects or information and may include exaggerated information compared to realistic representations.

### DETAILED DESCRIPTION

Hereinafter, example embodiments of the present disclosure will be described with reference to the accompanying drawings as follows.

The example embodiments of the present inventive concept may be modified in many different forms, and are provided to more completely explain to those skilled in the art. Accordingly, shapes and sizes of elements in the drawings may be exaggerated for clear description, and unless the context indicates otherwise, elements indicated by the same reference numeral are the same elements in the drawings.

It will be understood that when an element is referred to as being “connected” or “coupled” to or “on” another element, it can be directly connected or coupled to or on the other element or intervening elements may be present. In contrast, when an element is referred to as being “directly connected” or “directly coupled” to another element, or as “contacting” or “in contact with” another element (or using any form of the word “contact”), there are no intervening elements present at the point of contact.

In the present disclosure, expressions such as “first” and “second” are used to distinguish one component from another as a naming convention, and unless the context indicates otherwise, ordinal terms such as “first” and “second” do not limit the order and/or positioning of the components. For example, in some cases, for example, a first element described in the detailed description may be referred to as a second element in the claims, and similarly, a second element in the detailed description may also be referred to as a first element in the claims.

Terms used in the present inventive concept are only used to describe an example, and are not intended to limit the disclosure. Items described in the singular herein may be provided in plural, as can be seen, for example, in the drawings. Thus, the description of a single item that is provided in plural should be understood to be applicable to the remaining plurality of items unless context indicates otherwise.

X-ray equipment for semiconductor structure inspection according to an example embodiment of the present inventive concept may generate images of structures included in an object to be measured by radiating an X-ray beam to the object to be measured, such as a semiconductor device for defect inspection, or the like, and converting the X-ray beam into visible light.

X-ray equipment for semiconductor structure inspection according to an example embodiment of the present inventive concept may be used for measuring and inspecting not only a semiconductor wafer including a plurality of semiconductor dies, but also a semiconductor package product and a connection structure of a semiconductor package product.

For example, X-ray equipment for semiconductor structure inspection according to an example embodiment of the present inventive concept may be used to inspect structural defects that may appear in a bonding structure in which a plurality of semiconductor dies are stacked and connected to each other. For example, the X-ray equipment for semiconductor structure inspection according to an example embodiment of the present inventive concept may be used to inspect microscopic defects such as voids that may appear in a bonding structure such as a High Bandwidth Memory (HBM) device in which a plurality of semiconductor dies are stacked and connected by a microbump (μBump) of 1 μm or less, not-wet defects which are microscopic contact defects with an unclear degree of contact, and voids in a dielectric material other than metal. The X-ray equipment for semiconductor structure inspection according to an example embodiment of the present inventive concept may generate a high-resolution image in which the defects may be accurately expressed.

In an example embodiment, the X-ray equipment for semiconductor structure inspection according to an example embodiment of the present inventive concept may be automated with other semiconductor process systems to perform inspection in situ and/or inline method. The various systems may be controlled by a computer system configured to control the operation of the systems and the interaction between the systems based on one or more control programs or circuits that are configured to receive instructions from a user.

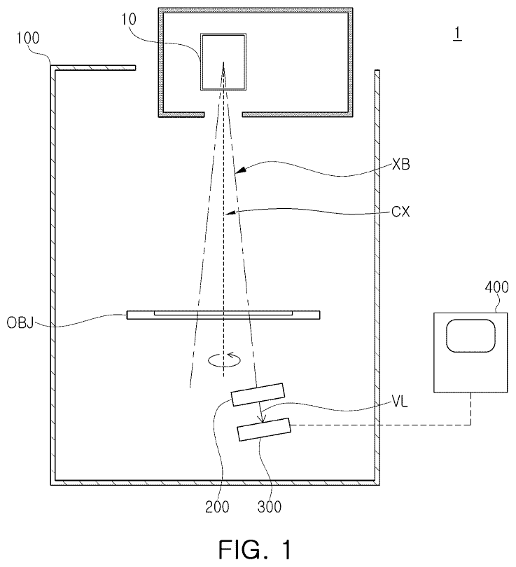

FIG. 1 is a schematic diagram of X-ray equipment for semiconductor structure inspection according to an example embodiment of the present inventive concept.

In a semiconductor process, inline inspection may be performed on an object to be inspected such as a semiconductor wafer, a semiconductor package, or the like, and the inspection may be performed by transferring the object to be inspected to the X-ray equipment for semiconductor structure inspection according to an example embodiment of the present inventive concept.

X-ray equipment 1 for semiconductor structure inspection according to according to an example embodiment of the present inventive concept may include an X-ray source 10, a chamber 100, a scintillator 200, a detector 300, a controller 400, and the like.

The X-ray equipment 1 for semiconductor structure inspection is an automated high-speed X-ray inspection system, and an object to be inspected OBJ may be transferred to the chamber 100 of the X-ray equipment 1 for semiconductor structure inspection. The object to be inspected OBJ transferred to the chamber 100 of the X-ray equipment 1 for semiconductor structure inspection may be fixed for inspection, and an X-ray source 10 may emit an X-ray beam XB to the object to be inspected OBJ. For example, the X-ray source 10 may radiate an X-ray beam XB to a target region, which may be a portion of the object to be inspected OBJ.

The X-ray equipment 1 for semiconductor structure inspection may include an X-ray source 10 emitting an X-ray beam XB, which is a type of radiation, and therefore, a chamber 100 may be formed of an X-ray absorbent material such as doped glass or plastic that can prevent and shield radiation leakage to the outside. The object to be inspected OBJ transferred into the chamber 100 may be fixed to a stage, or the like, and depending on the example embodiment, the object to be inspected OBJ may be fixed to a stage that can rotate around a predetermined axis.

The X-ray source 10 may radiate an X-ray beam XB obliquely toward the object to be inspected OBJ, and for example, an X-ray beam XB in the shape of a cone beam having a predetermined central axis CX may be radiated onto a target region of the object to be inspected OBJ. The X-ray beam XB may be partially absorbed in the target region of the object to be inspected OBJ and partially passes through the target region of the object to be inspected OBJ, and the X-ray beam XB having passed through the target region may be incident on a scintillator 200.

The scintillator 200 may be a light conversion device emitting visible light VL in response to an X-ray beam XB of a predetermined wavelength band. The visible light VL emitted by the scintillator 200 may be incident on a detector 300, and the detector 300 may output a detection signal in response to the visible light VL. Depending on the example embodiment, the scintillator 200 may be disposed between the object to be inspected OBJ and the X-ray source 10, rather than between the object to be inspected OBJ and the detector 300. Alternatively, the scintillator 200 may also be disposed between the object to be inspected OBJ and the X-ray source 10 and between the object to be inspected OBJ and the detector 300, respectively.

In an example embodiment, the detector 300 may be implemented as a Charge Coupled Device (CCD) sensor, a Complementary Metal-Oxide-Semiconductor (CMOS) image sensor, or the like. The detector 300 may generate a detection signal used or necessary to form image data, in response to the visible light VL emitted by the scintillator 200.

The object to be inspected OBJ may be a semiconductor wafer on which a plurality of semiconductor dies including integrated circuits are disposed, a semiconductor package including one or more semiconductor dies, or the like. In an example embodiment of the present inventive concept, by using the X-ray equipment 1 for semiconductor structure inspection, it is possible to inspect for structural defects in the integrated circuit included in each of the semiconductor dies, or defects appearing in a bonding structure of the semiconductor dies included in a semiconductor package. For example, in the bonding structure of the semiconductor package, structural defects found in a lower structure after bonding, such as microscopic defects such as voids formed inside a microbump (μBump) of 1 μm or less, or not-wet defects, microscopic contact defects caused by contact defects, may be inspected using the X-ray equipment 1 for semiconductor structure inspection according to an example embodiment of the present inventive concept.

A detection signal generated by the detector 300 may be transmitted to a controller 400. The controller 400 may include a processor including a core circuit for computational processing, and at least one image signal processor processing the detection signal received from the detector 300 to generate an image. For example, the image signal processor of the controller 400 may generate an image in which structures included in a target region of an object to be measured OBJ are expressed, by applying various image processing operations to the detection signal generated by the detector 300.

Depending on the example embodiment, the controller 400 may generate an image representing the target region of the object to be measured OBJ by using a plurality of the detection signals generated by the detector 300 through two or more imaging processes. For example, a first imaging process may be performed by applying a first scintillator emitting first visible light, as the scintillator 200 in response to a first selected wavelength band among wavelength bands of an X-ray beam XB, and a first detection signal may be received from the detector 300. Next, a second imaging process may be performed by applying a second scintillator emitting second visible light, as the scintillator 200 in response to a second selected wavelength band among the wavelength bands of the X-ray beam XB, and a second detection signal may be received from the detector 300.

The first selected wavelength band and the second selected wavelength band may be different from each other. For example, when the target region of the object to be measured OBJ includes measurement patterns formed of a first material and neighboring (e.g., adjacent) patterns formed of a second material and coupled to the measurement patterns, an absorption rate of the first material for an X-ray beam XB of the first selected wavelength band may be different from an absorption rate of the first material for an X-ray beam XB of the second selected wavelength band. In addition, the absorption rate of the second material for the X-ray beam XB of the first selected wavelength band may be different from the absorption rate of the second material for the X-ray beam XB of the second selected wavelength band.

Accordingly, by appropriately selecting the first selected wavelength band and the second selected wavelength band, and using a first image generated from the first detection signal and a second image generated from the second detection signal, the controller 400 may generate an image in which the measurement patterns and the neighboring patterns are clearly distinguished. Therefore, it is possible to accurately determine not only defects existing within the measurement patterns, but also defects existing at a boundary between the measurement patterns and the neighboring patterns.

In an example embodiment, the X-ray equipment 1 for semiconductor structure inspection may generate an image of the target region the object to be measured OBJ using an X-ray laminography technology. To this end, while an X-ray beam XB is radiated to the target region, the scintillator 200 and the detector 300 may rotate 360 degrees around a center axis CX so that the detector 300 may generate a first detection signal.

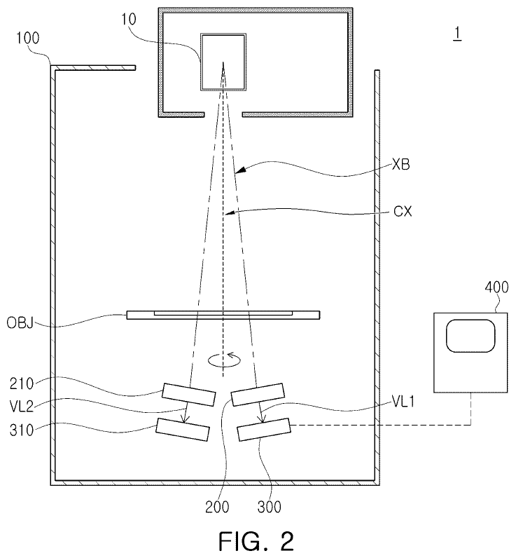

FIG. 2 is a schematic diagram of X-ray equipment for semiconductor structure inspection according to an example embodiment of the present inventive concept.

Referring to FIG. 2, the X-ray equipment 1 for semiconductor structure inspection according to an example embodiment illustrated in FIG. 2 may include an X-ray source 10, a chamber 100, a first scintillator 200, a first detector 300, a second scintillator 210, a second detector 310, a controller 400, and the like.

In the example embodiment illustrated in FIG. 2, the first scintillator 200 may emit first visible light VL1 in response to a first selected wavelength band among wavelength bands of an X-ray beam XB, and the second scintillator 210 may emit second visible light VL2 in response to a second selected wavelength band among the wavelength bands of the X-ray beam XB. The first selected wavelength band and the second selected wavelength band may be different from each other. Accordingly, a first detection signal generated by the first detector 300 in response to the first visible light VL1 may correspond to a first selected wavelength band, and a second detection signal generated by the second detector 310 in response to the second visible light VL2 may correspond to a second selected wavelength band. In an X-ray beam XB, the first selected wavelength band and the second selected wavelength band may be defined as different energy bands.

Similar to that previously described with reference to FIG. 1, the X-ray equipment 1 for semiconductor structure inspection according to an example embodiment of the present inventive concept may generate an image of a target region of an object to be measured OBJ using an X-ray laminography technology. To this end, while an X-ray beam XB is radiated to the target region, a first scintillator 200 and a first detector 300 may rotate 360 degrees around a center axis CX, and a second scintillator 300 and a second detector 310 may also rotate 360 degrees around the center axis CX.

For example, the first detector 300 and the second detector 310 may be disposed to be tilted toward each other in a direction parallel to an upper surface of the target region. The direction may be a direction penetrating through the center axis CX of the X-ray beam XB, the center of the target region, and perpendicular to the center axis CX. However, the disposition of the first detector 300 and the second detector 310 may be variously modified.

In the example embodiment illustrated in FIG. 2, a first scintillator 200 and a second scintillator 210 in reaction to different selected wavelength bands in a wavelength band of an X-ray beam XB may be disposed to match the first detector 300 and the second detector 310. Therefore, unlike the example embodiment illustrated in FIG. 1, a first image corresponding to a first selected wavelength band of the X-ray beam XB and a second image corresponding to a second selected wavelength band of the X-ray beam XB may be acquired through a single imaging process. By acquiring the first image corresponding to the first selected wavelength band and the second image corresponding to the second selected wavelength band through a single imaging process, an image in which regions including three different materials are displayed separately may be acquired through just a single imaging process.

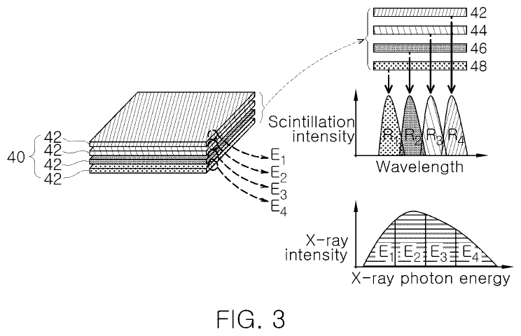

FIG. 3 is a schematic diagram illustrating a scintillator included in X-ray equipment for semiconductor structure inspection according to an example embodiment of the present inventive concept.

Referring to FIG. 3, a scintillator 40 included in X-ray equipment for semiconductor structure inspection according to an example embodiment of the present inventive concept may include a plurality of layers 42, 44, 46, and 48 emitting visible light in response to a specific wavelength band, in a broadband X-ray beam XB emitted from an X-ray source 10. Referring to FIG. 3, the scintillator 40 may include a plurality of layers 42, 44, 46, and 48, and depending on the example embodiment, the scintillator may be implemented by selecting only one or a portion of the layers 42, 44, 46, and 48. Each of the layers 42, 44, 46, and 48 may emit visible light in response to a specific wavelength band corresponding to an energy of the X-ray beam XB.

For example, the first layer 42 may emit visible light in response to a first wavelength band R1 corresponding to a first energy band E1, such that the first layer 42 may be selected by emitting only the first wavelength band R1 from the X-ray source 10, and the second layer 44 may emit visible light in response to a second wavelength band R2 corresponding to a second energy band E2, such that the second layer 44 may be selected by emitting only the second wavelength band R2 from the X-ray source 10. The third layer 46 may emit visible light in response to a third wavelength band R3 corresponding to a third energy band E3, and the fourth layer 48 may emit visible light in response to a fourth wavelength band R4 corresponding to a fourth energy band E4.

The scintillator 40 may be implemented by selecting one of the layers 42, 44, 46, and 48 emitting visible light in response to the X-ray beam XB of different energy bands, or by combining two or more of the layers 42, 44, 46, and 48. For example, in the X-ray equipment 1 for semiconductor structure inspection according to an example embodiment illustrated in FIG. 2, assuming that the first scintillator 200 is implemented as the first layer 42 and the second scintillator 210 is implemented as the third layer 46, the first detector 300 may generate a first detection signal in response to visible light generated by the X-ray beam XB of the first energy band E1, and the second detector 310 may generate a second detection signal in response to visible light generated by the X-ray beam XB of the third energy band E3.

When measurement patterns having a high absorption rate for the X-ray beam XB of the first energy band E1 and neighboring patterns having a low absorption rate for the X-ray beam XB of the second energy band E2 exist in the target region of the object to be measured OBJ, microscopic defects at a bonding surface between the measurement patterns and the neighboring patterns may be determined using the image generated from the first detection signal. In addition, when the material of the measurement patterns has different absorption rates for the X-ray beam XB of the first energy band E1 and the X-ray beam XB of the second energy band E2, an internal density and structure of the measurement patterns may be determined using the same.

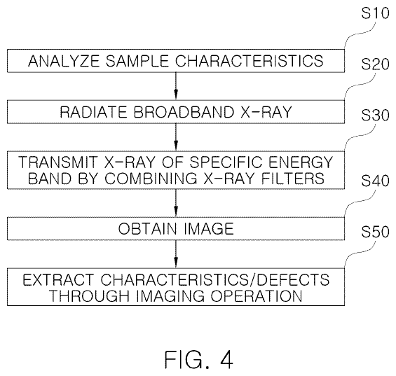

FIG. 4 is a flow chart of a method for inspecting a semiconductor structure using X-ray equipment for semiconductor structure inspection according to an example embodiment of the present inventive concept.

As described above, in the method for inspecting a semiconductor structure according to an example embodiment of the present inventive concept, while an X-ray beam is radiated obliquely onto a target region of an object to be inspected, the X-ray beam having passed through the target region may be converted into visible light by a scintillator and then is incident on a detector. By appropriately determining a selected wavelength band of an X-ray beam to which the scintillator reacts by considering the material of the measurement patterns to be disposed in the target region and to be inspected for defects, an image that can accurately identify the measurement patterns from the detection signal emitted by the detector may be generated.

Referring to FIG. 4, first, the characteristics of a sample of an object to be inspected may be analyzed (S10). In step S10, a selected wavelength band of an X-ray beam to which a scintillator reacts may be determined. For example, when measurement patterns to be determined to be defective through the inspection method are copper, a first scintillator having a first selected wavelength band may be selected, and when the measurement patterns are tungsten, a second scintillator having a second selected wavelength band, different from the first selected wavelength band may be selected.

A first scintillator and a second scintillator may be installed within X-ray equipment for semiconductor structural inspection. For example, in the example embodiment illustrated in FIG. 1, the first scintillator may be installed between an object to be inspected and a detector to perform a first imaging process, and if necessary, the second scintillator may be installed between the object to be inspected and the detector to perform a second imaging process (e.g., the second scintillator may replace the first scintillator during the second imaging process). Depending on the structure of the X-ray equipment for semiconductor structure inspection, a low pass filter may be installed between the X-ray source and the object to be inspected. For example, damage and defects that may occur in the object to be inspected due to the X-ray beam can be reduced, by placing the low pass filter between the X-ray source and the object to be inspected. Meanwhile, in the example embodiment illustrated in FIG. 2, the first scintillator may be installed between the object to be inspected and the first detector, and the second scintillator may be installed between the object to be inspected and the second detector.

Thereafter, when the object to be inspected is transferred into a chamber of the X-ray equipment for semiconductor structure inspection and fixed to a stage, or the like, a broadband X-ray beam may be radiated from an X-ray source 10 to the target region of the object to be inspected (S20). As previously described, an X-ray beam may be radiated obliquely to the target region, and for example, an X-ray beam in the shape of a cone beam may be radiated to the target region.

While the X-ray beam is radiated to the target region, a detector may generate a detection signal (S30). The detector may generate a detection signal in response to visible light emitted by the scintillator, and for example, when the detector is a CCD sensor or CMOS image sensor, the detection signal may include data necessary or used to generate an image. A processor controlling the X-ray equipment for semiconductor structure inspection may generate an image in which measurement patterns included in the target region are expressed using the detection signal generated by the detector.

The processor may perform characteristic/defect inspection on the target region by executing an operation using the image generated in step S40 (S50). For example, as described above, when measurement patterns included in the target region and neighboring patterns bonded to the measurement patterns are formed of different materials, a scintillator of a selected wavelength band having different absorption rates for the material of the measurement patterns and the material of the neighboring patterns may be selected in step S10. Therefore, in the image generated from the detection signal output by the detector, a contrast ratio between the measurement patterns and the neighboring patterns may be greatly displayed, and thus, it is possible to accurately determine whether there are defects in a bonding structure of the measurement patterns and the neighboring patterns.

In the X-ray equipment for semiconductor structure inspection according to the example embodiment described with reference to FIG. 1, multiple imaging processes may be performed by replacing the scintillators multiple times, and the scintillators replaced multiple times may have different selected wavelength bands. Also, in the X-ray equipment for semiconductor structure inspection according to the example embodiment described with reference to FIG. 2, an imaging process may be performed by applying scintillators having different selected wavelength bands to the X-ray equipment for semiconductor structure inspection that rotate about an axis. By using above methods, an image in which a structure and/or interface of patterns formed of three different materials is clearly expressed may be generated, and thus defects in a target region including a plurality of patterns may be accurately inspected.

In addition, by utilizing the characteristics that a single material has different absorption rates for different selected wavelength bands of the X-ray beam, microvoids, air bubbles, or the like, inside the measurement patterns may be accurately determined. For example, by applying a scintillator having a selected wavelength band in which a difference in absorption rates of the material forming the measurement patterns and the air is large to the X-ray equipment for semiconductor structure inspection, an image in which fine air bubbles and/or microvoids, etc. are clearly displayed may be generated.

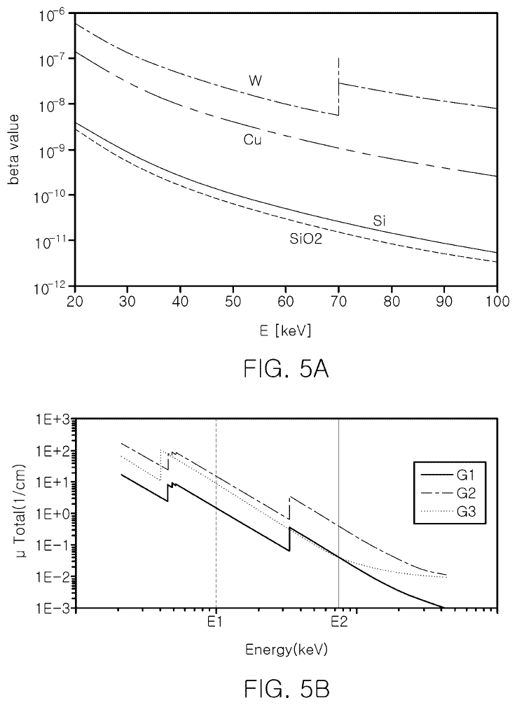

FIGS. 5A and 5B are graphs of a method for inspecting a semiconductor structure according to an example embodiment of the present inventive concept.

First, in the graph of FIG. 5A, a horizontal axis represents a wavelength band of an X-ray beam, and a vertical axis represents a linear attenuation coefficient according to the material. The horizontal axis represents an energy that an X-ray beam may have, and a wavelength of the X-ray beam may be inversely proportional to the energy.

Referring to FIG. 5A, the linear attenuation coefficient of each of tungsten (W), copper (Cu), silicon oxide (SiO2), and silicon (Si) are illustrated in a wavelength band. The linear attenuation coefficient may represent an absorption rate of each material according to the wavelength band of the X-ray beam. For example, a higher linear attenuation coefficient may indicate a higher material absorption. For example, an X-ray beam in a wavelength corresponding to an energy of 40 keV may be most absorbed by tungsten (W) and least absorbed by silicon dioxide (SiO2).

Referring to FIG. 5A, tungsten (W) and copper (Cu) may show a large difference in absorption rates in a wavelength band in which the energy of the X-ray beam is 70 keV or more. Therefore, when the target region includes measurement patterns formed of copper (Cu), and neighboring patterns located around the measurement patterns and formed of tungsten (W), a scintillator emitting visible light in response to an X-ray beam having an energy of 70 keV or more may be applied to the X-ray equipment for semiconductor structure inspection. By using an image generated from a detection signal generated by the detector by the visible light emitted from the scintillator, an interface structure between the measurement patterns formed of copper (Cu) and the neighboring patterns formed of tungsten (W) may be accurately inspected.

Meanwhile, when selecting a scintillator, the characteristics of the X-ray beam, depending on the energy of the X-ray beam, may also be considered. For example, as an intensity of the energy increases, i.e. the wavelength band decreases, a penetration depth of the X-ray beam may increase, but the risk of radiation exposure may also increase. On the other hand, if the intensity of the energy decreases, i.e. the wavelength band increases, a contrast of the generated image may increase and crosstalk may be reduced. Therefore, in an operation of inspecting materials having large differences in absorption rates regardless of the intensity of the energy, such as an interface structure between tungsten (W) and silicon oxide (SiO2), a scintillator emitting visible light in response to a low-energy X-ray beam may be selected.

FIG. 5B is a graph illustrating a linear attenuation coefficient of an X-ray beam according to a concentration of a specific material. In FIG. 5B, a first graph G1 may represent a linear attenuation coefficient for a first material at a first concentration, a second graph G2 may represent a linear attenuation coefficient for a first material at a second concentration, higher than the first concentration, and a third graph G3 may represent a linear attenuation coefficient for a second material at a second concentration.

For example, when a first scintillator in reaction to an X-ray beam of a first selected wavelength band E1 is applied to X-ray equipment for semiconductor structure inspection, a first material included in the target region and having a first concentration, and a second material having a second concentration may be clearly distinguished in the image. In addition, by applying the first scintillator to the X-ray equipment for semiconductor structure inspection, it is also possible to specify whether the concentration of the first material is closer to the first concentration or the second concentration.

However, when the target region includes a first material having a second concentration and a second material having a second concentration, the first material and the second material may not be clearly distinguished in the target region using the X-ray equipment for semiconductor structure inspection to which the first scintillator is applied. In such a case, in an example embodiment of the present inventive concept, by applying a second scintillator in reaction to an X-ray beam of a second selected wavelength band E2 to the X-ray equipment for semiconductor structure inspection, a first material included in the target region at the second concentration and a second material included in the target region at the second concentration may be distinguished. Referring to FIG. 5B, by applying a second scintillator in reaction to an X-ray beam of a second selected wavelength band E2 to the X-ray equipment for semiconductor structure inspection, a first material and a second material having the same second concentration may be clearly distinguished.

In an example embodiment of the present inventive concept, scintillators in reaction to different selected wavelength bands among the wavelength bands of the X-ray beam may be selectively applied to the X-ray equipment for semiconductor structure inspection. Therefore, as described with reference to FIG. 5A, an interface structure between patterns formed of different materials may be precisely inspected. In addition, as described with reference to FIG. 5B, it is also possible to specify the type of material included in the target region, or to measure the concentration of the material included in the target region.

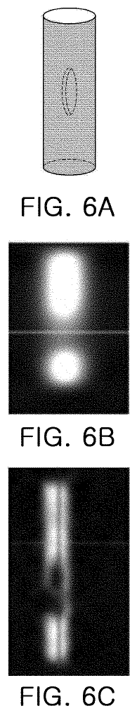

FIGS. 6A to 6C are diagrams illustrating inspection results of X-ray equipment for semiconductor structure inspection according to an example embodiment of the present inventive concept.

FIG. 6A is a simple diagram of a through silicon via (TSV) including a void. In a process of first forming a hole or trench through an etching process, or the like, and then filling the hole or trench with a conductive material, or the like, to form a through silicon via, a void may be formed because an internal space thereof is not sufficiently filled.

FIG. 6B is an image of a through silicon via including a void inspected using a device using a short wavelength X-ray beam. As illustrated in FIG. 6B, by using a device using a short wavelength X-ray beam, an image in which a void inside a through silicon via is accurately expressed may not be generated.

FIG. 6C is an image of a through silicon via including a void inspected using X-ray equipment for semiconductor structure inspection according to an example embodiment of the present inventive concept. As described above, in an example embodiment of the present inventive concept, a broadband X-ray beam may be radiated onto a target region of an object to be inspected, and a scintillator in reaction to a selected wavelength band among the wavelength bands of the X-ray beam may be disposed on a path of the X-ray beam. In this case, a selected wavelength band having different absorption rates for a conductive material forming the through silicon via, and air existing in the void may be produced, and a scintillator in reaction to the X-ray beam of the produced selected wavelength band may be applied to the X-ray equipment for semiconductor structure inspection. Therefore, as illustrated in FIG. 6C, an image in which voids inside the through silicon via are clearly expressed may be generated.

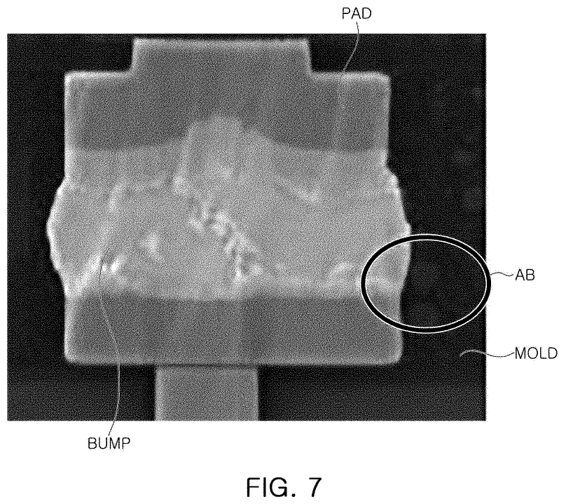

FIG. 7 is a diagram illustrating inspection results of X-ray equipment for semiconductor structure inspection according to an example embodiment of the present inventive concept.

FIG. 7 is an image of a bonding structure of an HBM device in which a plurality of semiconductor dies are stacked and connected. FIG. 7 may be an example of an image generated by radiating an X-ray beam to a target region including a bonding structure of an HBM device and executing a method for inspecting a semiconductor structure according to an example embodiment of the present inventive concept.

In the bonding structure of the HBM device, a plurality of bonding pads PAD may be connected to each other by a plurality of microbumps BUMP, and a space between a plurality of memory dies may be filled with a molding material MOLD such as epoxy, or the like. The reliability of such a bonding structure may be affected by defects existing at an interface between the bonding pad PAD and the microbumps BUMP and air bubbles AB formed within the molding material MOLD.

As previously described with reference to FIG. 6, in an example embodiment of the present inventive concept, by selecting a scintillator having an appropriate selected wavelength band, an image in which the interface between the bonding pad PAD and the microbumps BUMP and the air bubble AB inside the molding material MOLD are clearly expressed may be generated.

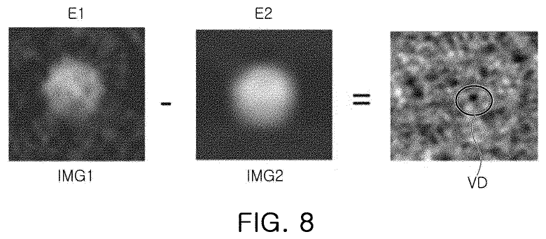

FIG. 8 is a diagram illustrating inspection results of X-ray equipment for inspecting a semiconductor structure according to an example embodiment of the present inventive concept.

In an example embodiment illustrated in FIG. 8, a first scintillator in reaction to an X-ray beam in a first energy band and a second scintillator in reaction to an X-ray beam in a second energy band may be applied to X-ray equipment for semiconductor structure inspection. A first image IMG1 may be generated by a first detection signal generated by a first detector in response to visible light emitted by a first scintillator, and a second image IMG2 may be generated by a second detection signal generated by a second detector in response to visible light emitted by a second scintillator. The first image IMG1 and the second image IMG2 may be generated through a plurality of imaging processes or through a single imaging process.

In an example embodiment illustrated in FIG. 8, an X-ray beam may be radiated onto a target region including a microbump, and for example, an operation to check whether defects such as a void, or the like exist inside the microbump may be performed. In each of the first image IMG1 and the second image IMG2, the void may not be clearly identified. However, in an example embodiment of the present inventive concept, a void VD existing in a microbump may be identified as illustrated in FIG. 8 by using a difference between the first image IMG1 and the second image IMG2. Therefore, the accuracy of semiconductor structure inspection may be improved.

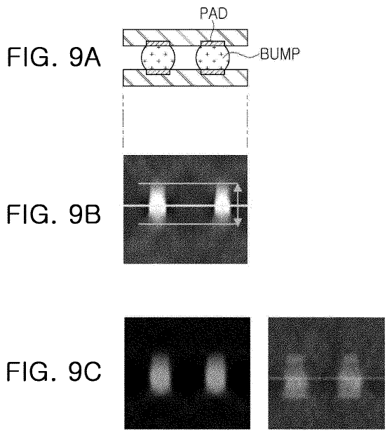

FIGS. 9A to 9C are diagrams illustrating inspection results of X-ray equipment for semiconductor structure inspection according to an example embodiment of the present inventive concept.

FIG. 9A is a simple diagram illustrating a bonding structure in which a plurality of semiconductor dies are bonded to each other. Referring to FIG. 9A, bonding pads PAD, facing each other may be bonded to each other and electrically connected to each other by micro bumps BUMP.

FIG. 9B is an image of a bonding structure as illustrated in FIG. 9A inspected by a device using a short-wavelength X-ray beam. As illustrated in FIG. 9B, in the device using a short-wavelength X-ray beam, bonding pads PAD and microbumps BUMP included in the bonding structure may not be accurately expressed in the image.

FIG. 9C is an image of a bonding structure as illustrated in FIG. 9A inspected using X-ray equipment for semiconductor structure inspection according to an example embodiment of the present inventive concept. As described above, in an example embodiment of the present inventive concept, a broadband X-ray beam may be radiated onto a target region of an object to be inspected, and a scintillator corresponding to a selected wavelength band among the wavelength bands of the X-ray beam may be disposed on a path of the X-ray beam.

In this case, a selected wavelength band having different absorption rates for a material forming the bonding pad PAD and a material forming the microbump BUMP may be produced, and a scintillator corresponding to the X-ray beam of the produced selected wavelength band may be applied to the X-ray equipment for semiconductor structure inspection. Therefore, as illustrated in FIG. 9C, an image in which the bonding structure is expressed in detail may be generated. In addition, by applying a scintillator corresponding to an appropriately selected wavelength band to X-ray equipment for semiconductor structure inspection, a concentration of the material included in microbumps may also be inspected.

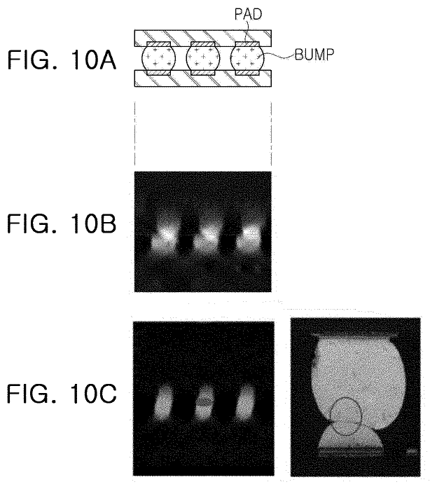

FIGS. 10A to 10C are diagrams illustrating inspection results of X-ray equipment for semiconductor structure inspection according to an example embodiment of the present inventive concept.

FIG. 10A is a simple diagram illustrating a bonding structure in which a plurality of semiconductor dies are bonded to each other. Referring to FIG. 10A, bonding pads PAD facing each other may be bonded to each other by microbumps BUMP and electrically connected to each other.

FIG. 10B may be an image of a bonding structure as illustrated in FIG. 10A inspected by a device using a short-wavelength X-ray beam. As illustrated in FIG. 10B, it may be difficult to accurately determine whether the bonding pads PAD and microbumps BUMP included in the bonding structure are in precise contact with the image generated by a device using a short-wavelength X-ray beam.

FIG. 10C is an image of a bonding structure as illustrated in FIG. 10A inspected using an X-ray equipment for semiconductor structure inspection according to an example embodiment of the present inventive concept. As described above, in an example embodiment of the present inventive concept, a broadband X-ray beam may be radiated onto a target region of an object to be inspected, and a scintillator in reaction to a selected wavelength band among the wavelength bands of the X-ray beam may be disposed on a path of the X-ray beam.

As previously explained, a selected wavelength band having different absorption rates for a material forming the bonding pad PAD and a material forming the microbump BUMP may be produced, and a scintillator corresponding to the X-ray beam of the produced selected wavelength band may be applied to the X-ray equipment for semiconductor structure inspection. Accordingly, as illustrated in FIG. 10C, an image in which a bonding structure is expressed in detail may be generated. In addition, inspection thereof may be performed by applying scintillators having different selected wavelength bands to the X-ray equipment for semiconductor structure inspection, so that it is possible to check a change in concentrations thereof according to the location of the microbumps BUMP, and therefrom, non-wet defects, in which microbumps BUMP are not connected to the pad PAD may be precisely detected.

As set forth above, according to an example embodiment of the present inventive concept, by selecting a portion of wavelength bands from an X-ray beam radiated onto a target region by an X-ray source, an image representing a structure included in the target region may be generated at high resolution, and based on the image, whether there are defects in the target region may be accurately determined.

In addition, by using filters passing different wavelength bands, it is possible to determine the defects in the target region in microscopic units, by selecting wavelength bands having different absorption rates for materials included in structures included in the target region.

In addition, it is possible to precisely determine structural defects such as voids and not-wet defects that may appear in a structure in which different semiconductor dies are stacked and bonded.

In addition, unlike the conventional X-ray equipment, aspects of the disclosed embodiments can accurately inspect microscopic defects such as air bubbles in a dielectric material having high transmittance.

In addition, in a structure in which measurement patterns and a neighboring patterns formed of different materials are bonded, an image in which the measurement patterns are expressed with a high signal-to-noise ratio may be generated, by obtaining a detection signal by selecting a wavelength band having a different absorption rate for each material.

In addition, the density of a specific material may be measured by utilizing the difference in transmittance of an X-ray beam for two or more wavelength bands.

The various advantages and effects of the present disclosure are not limited to the above-described content, and can be more easily understood through description of specific embodiments of the present disclosure.

While example embodiments have been shown and described above, it will be apparent to those skilled in the art that modifications and variations could be made without departing from the scope of the present disclosure, as defined by the appended claims.

What is claimed is:

1. X-ray equipment for semiconductor structure inspection, comprising:
an X-ray source configured to radiate an X-ray beam to a target region of an object to be inspected,
a scintillator configured to output visible light in a visible light wavelength band in response to a particular wavelength band among wavelength bands of the X-ray beam,
a detector configured to generate a detection signal in response to the visible light, and
a controller configured to determine defects in the object to be inspected using the detection signal,
wherein the scintillator is disposed between the object to be inspected and the detector.

2. The X-ray equipment for semiconductor structure inspection of claim 1, wherein the detector comprises a first detector and a second detector installed in different locations, and
wherein the scintillator comprises a first scintillator installed between the object to be inspected and the first detector, and a second scintillator installed between the object to be inspected and the second detector.

3. The X-ray equipment for semiconductor structure inspection of claim 2, wherein the first scintillator is configured to output first visible light in response to a first particular wavelength band among the wavelength bands of the X-ray beam, and
wherein the second scintillator is configured to output second visible light in response to a second particular wavelength band, different from the first particular wavelength band among the wavelength bands of the X-ray beam.

4. The X-ray equipment for semiconductor structure inspection of claim 3, wherein the controller is configured to generate an image of the target region using a first detection signal output by the first detector and a second detection signal output by the second detector.

5. The X-ray equipment for semiconductor structure inspection of claim 4, wherein the controller is configured to generate an image of the target region using a laminography method.

6. The X-ray equipment for semiconductor structure inspection of claim 4, wherein the target region comprises measurement patterns and neighboring patterns adjacent to the measurement patterns, and
wherein the first scintillator and the second scintillator have transmittance for first material included in the measurement patterns and second material included in the neighboring patterns, in each of the first particular wavelength band and the second particular wavelength band.

7. The X-ray equipment for semiconductor structure inspection of claim 2, wherein the first detector and the second detector are disposed to be tilted toward each other in a direction parallel to an upper surface of the target region, and the direction is a direction penetrating through a center axis of the target region and perpendicular to the center axis of the target region.

8. The X-ray equipment for semiconductor structure inspection of claim 7, wherein the controller is configured to rotate the first detector and the second detector 360 degrees while the X-ray beam is radiated onto the target region.

9. The X-ray equipment for semiconductor structure inspection of claim 1, wherein the X-ray source is configured to radiate the X-ray beam to the target region as a cone beam shape.

10. The X-ray equipment for semiconductor structure inspection of claim 1, further comprising:
a low pass filter installed between the X-ray source and the object to be inspected.

11. Inline X-ray equipment for semiconductor structure inspection, comprising:
an X-ray source configured to radiate a broadband X-ray beam within an X-ray wavelength band obliquely to a target region of an object to be inspected;
a first scintillator configured to output first visible light in response to a first particular wavelength band of the X-ray beam having passed through the target region;
a second scintillator configured to output second visible light in response to a second particular wavelength band of the X-ray beam having passed through the target region; and
a detector configured to output a detection signal in response to the first visible light and the second visible light.

12. The inline X-ray equipment for semiconductor structure inspection of claim 11, wherein the detector generates a first image corresponding to the first visible light and a second image corresponding to the second visible light.

13. The inline X-ray equipment for semiconductor structure inspection of claim 11, wherein the detector comprises a first detector receiving the first visible light and a second detector receiving the second visible light.

14. The inline X-ray equipment for semiconductor structure inspection of claim 13, configured such that while the X-ray beam is radiated onto the target region, the first detector rotates together with the first scintillator and the second detector rotates together with the second scintillator.

15. The inline X-ray equipment for semiconductor structure inspection of claim 11, wherein the first particular wavelength band and the second particular wavelength band are wavelength bands having different absorption rates depending on a concentration of a predetermined material.

16. The inline X-ray equipment for semiconductor structure inspection of claim 11, wherein the target region includes measurement patterns and a neighboring patterns adjacent to the measurement patterns and formed of a material different from that of the measurement patterns, and
the first particular wavelength band and the second particular wavelength band are wavelength bands having different absorption rates with respect to the measurement patterns.

17. The inline X-ray equipment for semiconductor structure inspection of claim 16, wherein the first particular wavelength band and the second particular wavelength band are wavelength bands having different absorption rates with respect to the neighboring patterns.

18. A method for inspecting a semiconductor structure, comprising:
radiating a target region of an object to be inspected with an X-ray beam having a cone beam shape;
exposing a detector to visible light using a scintillator reacting to the X-ray beam having passed through the target region;
obtaining a detection signal output by the detector; and
generating an image representing measurement patterns included in the target region using the detection signal,
wherein the image is generated using a first detection signal output by the detector and corresponding to a first particular wavelength band of the X-ray beam, and a second detection signal output by the detector and corresponding to a second particular wavelength band of the X-ray beam.

19. The method for inspecting a semiconductor structure of claim 18, further comprising:
selecting the scintillator by determining the first particular wavelength band having a first absorption rate for a material included in the measurement patterns, and the second particular wavelength band having a second absorption rate, different from the first absorption rate for the material included in the measurement patterns.

20. The method for inspecting a semiconductor structure of claim 18, wherein the detector is rotated 360 degrees to obtain the detection signal.
